(19) United States
(12) Patent Application Publication
(10) Pub. No.: US 2009/0161014 A1
(43) Pub. Date: Jun. 25, 2009

(54) Method for Displaying TV Program on Computer

(75) Inventors: Chun-Kai Chan, Taipei (TW); Ya-Shu Juang, Taipei (TW); Li-Hsiang Liao, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/265,919

(22) Filed: Nov. 6, 2008

(30) Foreign Application Priority Data
Dec. 21, 2007 (TW) 96149491

(51) Int. Cl. H04N 7/00

(52) U.S. Cl. 348/552

(57) ABSTRACT

A method for displaying TV program on a computer system is described. An operation system of the computer system is started and a memory-resident program is simultaneously loaded to continuously detecting whether or not a predetermined TV signal transforming device is electrically coupled with the computer system and established. A TV displaying program is executed by means of the memory-resident program when the TV signal transforming device is electrically coupled with the computer system.

### RELATED APPLICATIONS

This application claims priority to Taiwan Application Serial Number 96149491, filed Dec. 21, 2007, which are herein incorporated by reference.

### BACKGROUND

1. Field of Invention

The present invention relates to a method for displaying TV (Television) program on computer. More particularly, the present invention relates to a method for automatically displaying TV program on computer.

2. Description of Related Art

More and more persons own computers, hence have more chances to use computers, i.e. notebook computers, to display and watch TV programs. Users may buy a TV tuner box or TV tuner card and install it into a computer, and then watch TV programs by the computer instead of buying a Television, which usually occupies more space, to watch TV programs.

After the TV tuner box or TV tuner card is plugged into the computer, users need to manually execute a TV displaying program before watching TV programs. It is still somewhat inconvenient for users to manually execute a TV displaying program before they can watch TV programs.

### SUMMARY

It is therefore an objective of the present invention to provide an improved method for displaying TV program on a computer system.

In accordance with the foregoing and other objectives of the present invention, a method for displaying TV program on a computer system is provided. An operation system of the computer system is started and a memory-resident program is simultaneously loaded to continuously detecting whether or not a predetermined TV signal transforming device is electrically coupled with the computer system. A TV displaying program is executed by means of the memory-resident program when the predetermined TV signal transforming device is electrically coupled with the computer system. The TV displaying program is terminated by means of the memory-resident program when the predetermined TV signal transforming device is not electrically coupled with the computer system.

Thus, users merely plug a TV signal transforming device into a computer system or unplug the TV signal transforming device from the computer system to selectively execute or terminate a TV displaying program. That is, TV program is displayed on the Monitor soon after plugging the TV signal transforming device into the computer system, and TV program is terminated and disappeared on the Monitor soon after unplugging the TV signal transforming device from the computer system. Thus, manually executing or terminating the TV displaying program is unnecessary.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a method flowchart for displaying TV program on computer according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

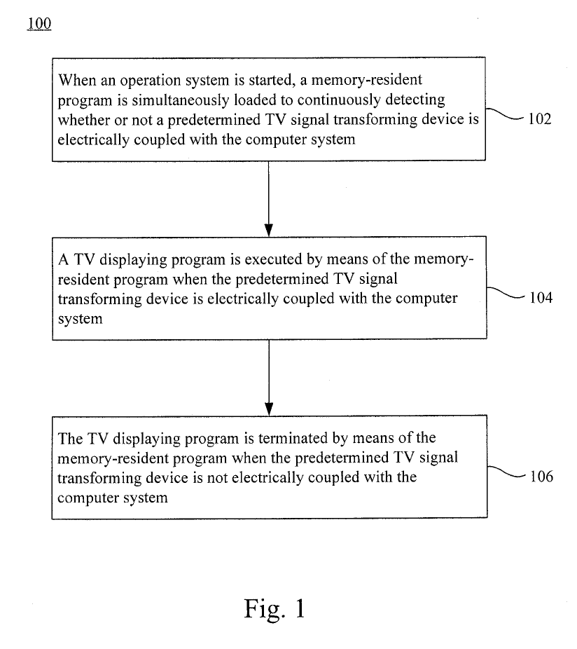

FIG. 1 illustrates a flowchart of TV displaying method 100 on computer according to one preferred embodiment of this invention. In this preferred embodiment, a memory-resident program and a TV displaying program are previously installed into a computer system. In step 102, the memory-resident program is simultaneously loaded when an operation system, i.e. Windows system, MS-DOS or Unix system, is started. By “memory-resident program”, it means a program that stays resident in memory, e.g. RAM, after it finishes executing, so it may resume executing later in response to a particular event (such as a hardware interrupt, e.g. electrical connection or disconnection). In this preferred embodiment, the memory-resident program stays resident in memory of the computer system to continuously detect an electrical connection or disconnection between the computer system and a TV signal transforming device, i.e. whether or not the TV signal transforming device is plugged into the computer system. The TV signal transforming device can be a TV tuner card, TV tuner box or TV tuner rod, of which one terminal is electrically coupled with the computer and the other terminal is electrically coupled with a TV signal source. The TV signal transforming device serves to convert a TV signal source into a signal format to be displayed by the TV displaying program. The TV signal transforming device can be electrically coupled with the computer via any hot plug interface, i.e. USB (Universal Serial Bus) or PCMCIA (Personal Computer Memory Card International Association) interface. The TV signal transforming device can also be a device which has an antenna for receiving wireless TV program signals broadcasted by a TV program broadcast station.

In step 104, the TV displaying program is executed by means of the memory-resident program when the TV signal transforming device is electrically coupled with the computer system, i.e. the TV signal transforming device is plugged into the computer system.

In step 106, the TV displaying program, which has been executed in step 104, is terminated by means of the memory-resident program when the TV signal transforming device is electrically coupled with the computer system, i.e. the TV signal transforming device is unplugged from the computer system.

According to discussed embodiments, users merely plug a TV signal transforming device into a computer system or unplug the TV signal transforming device from the computer system to selectively execute or terminate a TV displaying program. That is, TV program is displayed on the Monitor soon after plugging the TV signal transforming device into the computer system, and TV program is terminated and disappeared on the Monitor soon after unplugging the TV signal transforming device from the computer system. Thus, manually executing or terminating the TV displaying program is unnecessary.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for displaying TV program on a computer system, comprising:
simultaneously starting an operation system of the computer system and loading a memory-resident program, which continuously detecting whether or not a predetermined TV signal transforming device is electrically coupled with the computer system; and
executing a TV displaying program by means of the memory-resident program when the predetermined TV signal transforming device is electrically coupled with the computer system.

2. The method for displaying TV program of claim 1, further comprising the step of terminating the TV displaying program by means of the memory-resident program when the predetermined TV signal transforming device is not electrically coupled with the computer system.

3. The method for displaying TV program of claim 1, wherein the predetermined TV signal transforming device is electrically coupled with the computer system by a USB interface.

4. The method for displaying TV program of claim 1, wherein the predetermined TV signal transforming device is electrically coupled with the computer system by a PCMCIA interface.

5. The method for displaying TV program of claim 1, wherein the predetermined TV signal transforming device is electrically coupled with a TV signal source.

6. The method for displaying TV program of claim 1, wherein the predetermined TV signal transforming device comprises an antenna for receiving wireless TV signals.

7. The method for displaying TV program of claim 1, further comprising the step of installing the TV displaying program and the memory-resident program into the computer system.

8. The method for displaying TV program of claim 1, wherein the predetermined TV signal transforming device is a TV tuner card, TV tuner box or TV tuner rod.

9. The method for displaying TV program of claim 1, further comprising the step of converting a TV signal source into a signal format, to be displayed by the TV displaying program, by means of the predetermined TV signal transforming device.
